(19) United States
(12) Patent Application Publication
(10) Pub. No.: US 2017/0242051 A1
(43) Pub. Date: Aug. 24, 2017

(54) Gyroscope-free orientation measurement using accelerometers and magnetometer

(71) Applicant: Vishesh Vikas, Cambridge, MA (US)

(72) Inventor: Vishesh Vikas, Cambridge, MA (US)

(21) Appl. No.: 14/949,269

(22) Filed: Nov. 23, 2015

(51) Int. Cl. G01P 15/18; G01P 3/50; G01P 3/44

(52) U.S. Cl. CPC G01P 15/18; G01P 3/44; G01P 3/50

(57) ABSTRACT

The gyroscope-free accelerometer based inertial sensor allows for instantaneous (not time-recursive) measurement of angular velocity, angular acceleration of the rigid body, and linear acceleration of any point on the rigid body. The analytical solution to obtain orientation measurements (angular velocity and angular acceleration) does not require knowledge of body dynamics. Measurement of the rigid body angular acceleration can be used to estimate angular velocity in sensor fusion of various inertial and non-inertial sensor. For a body moving on ground with a point of contact with zero relative acceleration, the sensor can compensate for non-gravitational, dynamic acceleration, thus, is capable of separating gravity from motion. The presented accelerometer-magnetometer based sensor can uniquely measure the orientation between two bodies with a point of contact with zero relative acceleration (e.g. a rotating joint).

### SUMMARY OF THE INVENTION

The invention presents accelerometer based inertial sensor comprising of four non-coplanarly placed accelerometers (and one magnetometer). The sensors instantaneously measure (not estimate) orientation, angular velocity and angular acceleration of the rigid body without use of gyroscopes. The accelerometer-magnetometer based sensor also allows for calculation of unique rotation matrix between reference and current orientation of the body.

In some embodiments, combination of four or more non-coplanarly placed accelerometers on a rigid body can instantaneously measure the angular acceleration, angular velocity and linear acceleration of any point on the rigid body.

In some embodiments, given two (or more) rigid bodies with common point(s) with zero relative linear acceleration (defined as the point(s) common to two or more rigid bodies), then, four or more non-coplanarly placed accelerometers on each body can instantaneously measure the angular acceleration, angular velocity of the rigid bodies and also the linear acceleration of the common point(s) measured in coordinate systems fixed in respective body reference frames.

In some embodiments, let two (or more) rigid bodies have instantaneous common point(s) with zero relative linear acceleration (defined as the point(s) that is common to two or more rigid bodies). Then, four or more non-planarly placed accelerometers and one or more magnetometer(s) can instantaneously measure the unique rotation matrix between the coordinate systems fixed in respective body reference frames, angular velocity and angular acceleration of the rigid bodies, and linear acceleration of any point on the respective rigid bodies.

In some embodiments, given two rigid bodies joined by a revolute joint, then, the angular velocity, angular acceleration and joint angle between the rigid bodies can be instantaneously measured by using four or more non-coplanarly placed accelerometers on each body.

In some embodiments, given two rigid bodies joined by a universal joint, then, the angular velocity, angular acceleration and universal joint Euler rotation angles between the rigid bodies can be instantaneously measured by using four or more non-coplanarly placed accelerometers on each body.

An assembly comprising a combination of four or more non-coplanarly placed linear triaxial accelerometers on a rigid body, wherein the combination instantaneously measures the angular acceleration and angular velocity of the rigid body, and linear acceleration associated with any point on the rigid body.

An assembly comprising a combination of four or more non-coplanarly placed linear triaxial accelerometers and one or more magnetometers on a rigid body, wherein the combination instantaneously measures angular acceleration, angular velocity and magnetic field of the rigid body, and linear acceleration associated with any point on the rigid body.

An assembly comprising of two or more rigid bodies, wherein the assembly comprises of at least one point common to the two or more rigid bodies, wherein the common point instantly lies on both the rigid bodies and has zero relative linear acceleration between the two rigid bodies.

The assembly comprising of two or more rigid bodies, wherein the assembly comprises of at least one point common to the two or more rigid bodies, wherein the common point instantly lies on both the rigid bodies and has zero relative linear acceleration between the two rigid bodies, and each rigid body comprises of an assembly comprising a combination of four or more non-coplanarly placed linear triaxial accelerometers on a rigid body, wherein the combination instantaneously measures the angular acceleration and angular velocity of the rigid body, and linear acceleration associated with any point on the rigid body. The presented assembly, wherein the at least one common point is modeled as a revolute joint, and wherein the revolute joint angle is instantaneously calculated. The presented assembly, wherein the at least one common point is modeled as a universal joint, and wherein two Euler angles of the universal joint are instantaneously calculated.

The assembly comprising of two or more rigid bodies, wherein the assembly comprises of at least one point common to the two or more rigid bodies, wherein the common point instantly lies on both the rigid bodies and has zero relative linear acceleration between the two rigid bodies, and each rigid body comprises of an assembly comprising a combination of four or more non-coplanarly placed linear triaxial accelerometers and one or more magnetometers on a rigid body, wherein the combination instantaneously measures angular acceleration, angular velocity and magnetic field of the rigid body, and linear acceleration associated with any point on the rigid body. The presented assembly, wherein a rotation matrix between coordinate systems associated with both the rigid bodies is instantaneously calculated.

### BRIEF DESCRIPTION OF THE DRAWINGS

FIG. 1 is a diagram of the Accelerometer-based Dynamic Inclinometer (ADI) consists of four or more accelerometers A₁,A₂, . . . , A_{(N-1)},A_{N} for N≧4 which are located in non-coplanar arrangement. The sensor is identified by point P.

FIG. 2 is a diagram for the Accelerometer Magnetometer-based Dynamic Inclinometer (AMDI) consists of four or more accelerometers A₁,A₂, . . . , A_{(N-1)},A_{N} for N≧4 placed in non-coplanar arrangement and a magnetometer M. The sensor is identified by point P.

FIG. 3 is a diagram of rigid bodies B and C in contact at point O. The sensor S identified by point P is located on rigid body B.

FIG. 4 is a diagram of rigid bodies B and C in contact at point O. The sensors S_{B}, S_{C} identified by points P_{B}, P_{C} are located on rigid bodies B and C respectively.

### DETAILED DESCRIPTION OF THE INVENTION

The present invention is related to measuring orientation, angular velocity and angular acceleration of objects moving on ground. It can be used to measure joint angles, angular velocities and angular acceleration of link mechanisms. The invention is a sensor that uses four (or more) accelerometers coupled with a magnetometer when required. The sensors are computationally cheap (due to existence of analytical solution) and measure (not estimate) orientation, angular velocity and acceleration of objects.

Inertial sensors—both accelerometers and gyroscopes, are used for orientation estimation. Gyroscopes are used to measure the angular velocity and strapdown integration algorithms calculate the relative change in orientation by integrating the angular velocity. However, small errors in angular velocity (gyroscope signal) give rise to cumulative integration errors. For measuring absolute orientation, setting reference orientation is more fruitful as compared to estimating/measuring relative change in orientation (cummulation of error). To obtain better estimates, orientation estimation is also performed using sensors called Inertial Measurement Units (IMUs) which fuse accelerometer and gyroscope data. The usual practice is to use three single-axis accelerometers and three single-axis gyroscopes aligned orthogonally. A Kalman filter with knowledge of (error) dynamics of the system is applied to minimize these errors. Gyroscope-free designs using only accelerometers have been explored for measuring angular velocity and linear acceleration. Human vestibular system motivated inclination measurement has been researched. These use symmetric placement of accelerometers and a gyroscope to measure the inclination parameters. The sensors do not use any filtering/estimation technique and are free of integration error.

The invention is a gyroscope-free sensor comprising of accelerometers and magnetometer(s) that allow for the measurement of inclination parameters at every instance of time. It does not require symmetric placement of accelerometers and is free of integration errors.

Nomenclature
a_{P} Acceleration of point P
a_{P}^{A} Acceleration of point P expressed in coordinate system A
ω^{B} Angular velocity of coordinate system B w.r.t. inertial reference frame
α^{B} Angular acceleration of coordinate system B w.r.t. inertial reference frame
b Three dimension vector defined as b=[b₁,b₂,b₃]
bᵢ ith component of vector b where i=1,2 or 3
\hat{b} Cross product linear operator for vector b defined as

$$\hat{b} = [ \begin{matrix}0 & - {b}_{3} & {b}_{2} \\ {b}_{3} & 0 & - {b}_{1} \\ - {b}_{2} & {b}_{1} & 0\end{matrix} ]$$

b^{A} Vector b expressed in coordinate system A
r_{P→Q} Displacement vector from point P to point Q
_{A}^{B}R Rotation matrix between coordinate system A and B such that for a vector b, b^{B}=_{A}^{B}Rb^{A}

Problem Formulation

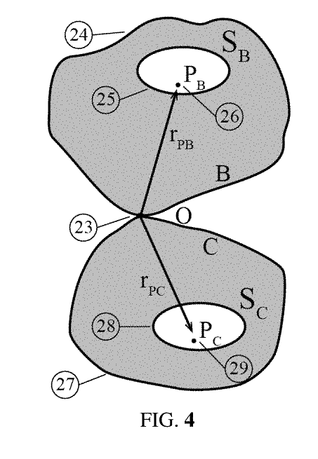

Given two rigid bodies B (18, 24) and C (19, 27) as show in FIG. 3 and FIG. 4. The point O is the point of instantaneous contact i.e.

a_{O}^{B}=_{C}^{B}Ra_{O}^{C}

Where the coordinate systems B, C are fixed in reference frames of bodies B and C respectively. The orientation between coordinate systems B, C is expressed in _{C}^{B}R

Multiple Accelerometer Calculations

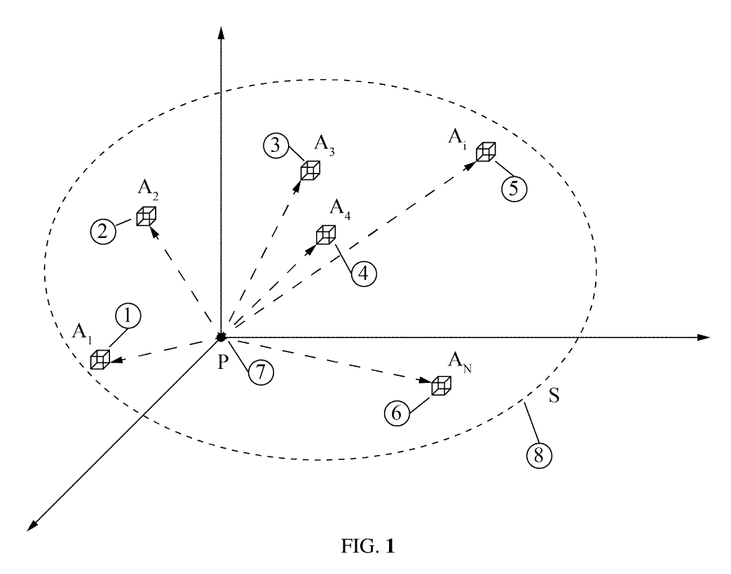

The N accelerometers N≧4 (1, 2, 3, 4, 5, 6) are arranged non-coplanarly as shown in FIG. 1. Given the placement of each accelerometer from point P, acceleration of each accelerometer may be written as

$$\begin{matrix}{a}_{{A}_{i}} = {a}_{P} + D ( {r}_{P \to {A}_{i}} ) x & ( 1 ) \\ D ( r ) = [ \begin{matrix}0 & - {r}_{1} & - {r}_{1} & {r}_{2} & 0 & {r}_{3} & 0 & {r}_{3} & - {r}_{2} \\ - {r}_{2} & 0 & - {r}_{2} & {r}_{1} & {r}_{3} & 0 & - {r}_{3} & 0 & {r}_{1} \\ - {r}_{3} & - {r}_{3} & 0 & 0 & {r}_{2} & {r}_{1} & {r}_{2} & - {r}_{1} & 0\end{matrix} ] & ( 2 ) \\ x = {[ {ω}_{1}^{2} , {ω}_{2}^{2} , {ω}_{3}^{2} , {ω}_{1} {ω}_{2} , {ω}_{2} {ω}_{3} , {ω}_{3} {ω}_{1} . {α}_{1} , {α}_{2} , {α}_{3} ]}^{T} & ( 3 ) \\ {A}_{3 N \times 1} = {[ {( {a}_{{A}_{1}} - {a}_{{A}_{2}} )}^{T} , {( {a}_{{A}_{2}} - {a}_{{A}_{3}} )}^{T} , {⋯ ( {a}_{{A}_{( N - 1 )}} - {a}_{{A}_{N}} )}^{T} ]}^{T} & ( 4 ) \\ {Λ}_{3 N \times 9} = {[ {D ( {r}_{{A}_{1} \to {A}_{2}} )}^{T} , {D ( {r}_{{A}_{2} \to {A}_{3}} )}^{T} , ⋯ {D ( {r}_{{A}_{( N - 1 )} \to {A}_{N}} )}^{T} ]}^{T} & ( 5 ) \\ Λ x = A & ( 6 ) \\ {x}^{*} = {Λ}^{+} A & ( 7 )\end{matrix}$$

Here x* denotes the least squares solution and Λ⁺ is the pseudoinverse of the matrix Λ. Non-coplanar arrangement of four or more accelerometers makes the columns of Λ to be linearly independent. This allows for solving of angular acceleration (α*) of the sensor reference frame w.r.t. the inertial reference frame as expressed in sensor coordinate system as

α*=[x*₇, x*₈, x*₉]^{T} (8)

Two sets of solutions for angular velocity (ω*) can be obtained from following set of equations

[(ω*₁)² (ω*₂)² (ω*₃)² ω*₂ ω*₃ ω*₃ω*₁]=[x*₁ x*₂ x*₃ x*₄ x*₅ x*₆] (9)

The acceleration of point P can now be calculated as

a*_{P}=a_{A}_{ᵢ}+D(r_{P→A}_{ᵢ})x* (10)

In conclusion, the non-coplanarly arranged accelerometers are able to output x*, ω*, α*, a*_{P} measured (and represented) in the coordinate system of the sensor. The acceleration of any other point Q located on the same rigid body can be calculated as

a_{Q}=a_{P}+D(r_{P→Q})x* (11)

For the bodies (18, 19 and 24, 27) shown in FIG. 3 and FIG. 4,

a_{O}^{B}=_{C}^{B}Ra_{O}^{C} (12)

If point of contact O (20, 23) can be modeled as a revolute or universal hooke joint, then, _{C}^{B}R can be represented by only one or two Euler rotations. In this case, it is possible to analytically solve for two sets of Euler rotation angles.

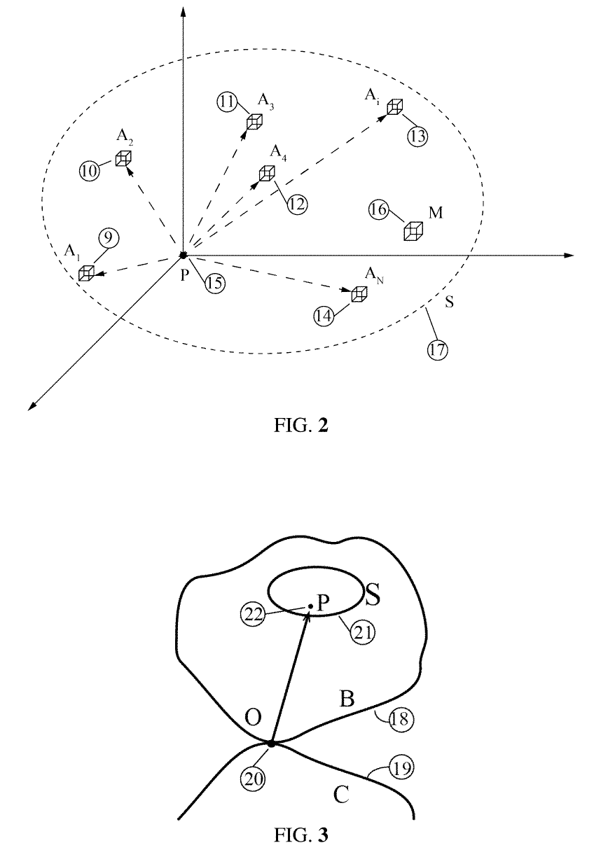

When combining the accelerometers (9, 10, 11, 12, 13, 14) with magnetometer (16) to make a sensor (17) as shown in FIG. 2, then readings from the magnetometer may be written as

m_{B}=_{C}^{B}Rm^{C} (13)

As the magnetic and gravitational fields are non-collinear, the traditional TRIAD algorithm can be used to uniquely solve for the rotation matrix. For Γ^{D}=[ä_{O}^{D}, \ddot{m}^{D}, (ä_{O}^{D}×\ddot{m}^{D})] for D=B,C and \ddot{v}=v/∥v∥₂ (unit vector).

_{C}^{B}R=Γ^{B}(Γ^{C})¹ (14)

The problem can also be written as a Wahba's problem i.e. minimization of loss function L(R) where R represents _{C}^{B}R, {yᵢ} is a set of N unit vectors measured in coordinate system B, {zᵢ} are the corresponding unit vectors in coordinate system C and λᵢ are non-negative weights i.e. {yᵢ}={ä_{O}^{B}, \ddot{m}^{B}, (ä_{O}^{B}×\ddot{m}^{B})} and {zᵢ}={ä_{O}^{C}, \ddot{m}^{C}, (ä_{O}^{C}×\ddot{m}^{C})}. The solution to the Wahba's problem using Davenport's q-method, SVD method, etc. has been widely researched in literature.

$$L ( R ) = \frac{1}{2} {\sum }_{i = 1}^{3} {λ}_{i} ∥ {y}_{i} - {Rz}_{i} {∥}^{2} \qquad ( 15 )$$

1. An assembly comprising a combination of four or more non-coplanarly placed linear triaxial accelerometers on a rigid body, wherein the combination instantaneously measures the angular acceleration and angular velocity of the rigid body, and linear acceleration associated with any point on the rigid body.

2. An assembly comprising a combination of four or more non-coplanarly placed linear triaxial accelerometers and one or more magnetometers on a rigid body, wherein the combination instantaneously measures angular acceleration, angular velocity and magnetic field of the rigid body, and linear acceleration associated with any point on the rigid body.

3. An assembly comprising of two or more rigid bodies, wherein the assembly comprises of at least one point common to the two or more rigid bodies, wherein the common point instantly lies on both the rigid bodies and has zero relative linear acceleration between the two rigid bodies.

4. The assembly of claim 3, wherein the each rigid body comprises of an assembly comprising a combination of four or more non-coplanarly placed linear triaxial accelerometers on a rigid body, wherein the combination instantaneously measures the angular acceleration and angular velocity of the rigid body, and linear acceleration associated with any point on the rigid body.

5. The assembly of claim 4, wherein the at least one common point is modeled as a revolute joint, and wherein the revolute joint angle is instantaneously calculated.

6. The assembly of claim 4, wherein the at least one common point is modeled as a universal joint, and wherein two Euler angles of the universal joint are instantaneously calculated.

7. The assembly of claim 3, wherein the each rigid body comprises of an assembly comprising a combination of four or more non-coplanarly placed linear triaxial accelerometers and one or more magnetometers on a rigid body, wherein the combination instantaneously measures angular acceleration, angular velocity and magnetic field of the rigid body, and linear acceleration associated with any point on the rigid body.

8. The assembly of claim 7, wherein a rotation matrix between coordinate systems associated with both the rigid bodies is instantaneously calculated.
